(19) United States
(12) Patent Application Publication
(10) Pub. No.: US 2006/0237543 A1
(43) Pub. Date: Oct. 26, 2006

(54) Card, manufacturing method of card, and thin type battery for card

(75) Inventors: Tomohisa Goto, Iwakura (JP); Sadamitsu Harada, Kakamigahara (JP)

Correspondence Address: KUSNER & JAFFE;HIGHLAND PLACE SUITE 310, 6151 WILSON MILLS ROAD, HIGHLAND HEIGHTS, OH, 44143, US

(73) Assignee: NGK Spark Plug Co., LTD.

(21) Appl. No.: 11/110,020

(22) Filed: Apr. 20, 2005

(51) Int. Cl. G06K 19/06

(52) U.S. Cl. 235/492

(57) ABSTRACT

The invention presents a method for manufacturing an IC card with a built-in battery where the seal of the battery does not breakdown during a heating and laminating process. The manufacturing method for the IC card of the invention includes accommodating a thin type battery 1 in a cavity 79 formed by overlaying an inner sheet 73 and a first oversheet 74 on a core sheet 72 having a penetration pole 79a. A second oversheet 75 covers the cavity 79, and a spacer 25 is inserted between a seal section 11 of the thin type battery 1 and second oversheet 75. Pressure and heat are applied to mutually adhere the sheets, wherein the pressing force is applied to the seal section 11 by way of the spacer 25.

### FIELD OF THE INVENTION

The present invention relates to a card, a manufacturing method of a card, and a thin type battery for a card.

### BACKGROUND OF THE INVENTION

As magnetic cards are being replaced by other storage mediums, a card (also called IC card) incorporating a storage device or microcomputer is receiving significant attention. Methods of supplying power for saving information or executing operations includes a method of making use of electromotive force by electromagnetic induction, and a method of supplying power from a built-in battery. The former is excellent because it is not necessary to consider the battery life, but the information saved in the IC card cannot be read without a reader/writer. An internal battery is needed if operated using a display unit such as a liquid crystal panel. By combining these two power supply methods, power can be supplied stably, and the IC card can be used for multiple functions.

The battery built in the IC card must be thin. For example, a thin type lithium primary cell 1 shown in FIG. 9 and FIG. 10 has an electrode container composed of metal current collectors 7, 8 and resin-made frame sheet members 2, 3, which is partitioned by separator 9, and contains a positive electrode active material 6 and a negative electrode active material 5. To minimize transmission of moisture into the inside of the battery, the thickness of frame sheet members 2, 3 is adjusted to a minimum. As a result, the main body 12, enclosed by outer shell 11 of battery (also known as seal section 11), is shaped upward like a trapezoidal form.

The manufacturing method of an IC card is generally comprised of a method of heating and laminating a plurality of resin sheets. Specifically, a core sheet having penetration holes is overlaid on an inner sheet for supporting internal components such as a battery and an IC module, thus forming a cavity for containing a battery or an IC. Oversheets are laminated from above and beneath, and integrally heated and laminated (thermally compressed)

In this heating and laminating process, a large pressure may be applied to the battery that breaks down the seal, and the electrode active material may leak out. Such inconvenience is likely to occur in a battery formed thickly in the portion weak to pressure, such as thin type battery 1 shown in FIG. 9. In the heating and laminating process of manufacturing an IC card, the press condition is set at a lower temperature and a lower pressure than in a conventional manufacturing method for a magnetic card, but it is hard to completely prevent breakdown of a battery seal by adjustment of the pres condition.

Since the IC card is put in a wallet and carried, the same seal breakdown may occur during use as during manufacture. This problem cannot be avoided solely by adjustment of the press condition in the heating and laminating process.

In the case of a battery that does not have a hard container, such as a coin type battery, a battery shape change is relatively large due to movement of active material from one electrode to other electrode. In a long course of IC card use, it is feared that the battery shape change may appear on the IC card surface. While there may not be a serious problem with IC card function, the appearance of the IC card may be impaired. Hence, users are demanding an IC card with a built-in battery, where the IC card has only small changes in shape due to battery shape changes.

For example, in the lithium primary cell having the configuration as shown in FIG. 9 and FIG. 10, as the discharge progresses, the thickness of the battery decreases. As a result, a battery firmly fixed in the card at the time of the manufacture of the IC card, may gradually get loose. Looseness of a battery in the card is not preferred in consideration of connection reliability between the card side terminal and battery terminal.

In the light of the above problems, it is hence an object of the invention to provide a card with a built-in battery that does not have a battery seal breakdown during use. It is another object to present a manufacturing method of a card with built-in battery where the battery seal does not breakdown during a heating and laminating process, or during use. It is another object to present a card with a built-in battery that has an excellent appearance and minimal shape changes due to battery shape changes, and its method of manufacture. It is still another object to present a card with a built-in battery that has the battery firmly fixed in the card throughout its time of use, and during its manufacture. It is yet a further object to present a thin type battery preferably usable in these cards.

### SUMMARY OF THE INVENTION

To solve the foregoing problems, a first aspect of the invention relates to a card comprising a thin plate battery having the inside of the battery kept airtight by a seal section to which a resin-made frame sheet member is adhered. The thickness of the seal section is adjusted to be smaller than the thickness of the main body enclosed by the seal section. An upper sheet is heated and laminated to cover a cavity formed in a core sheet. The thin type battery is located in the cavity, and a spacer for tightly adhering the upper sheet and core sheet is inserted between the seal section of the thin type battery and the upper sheet.

According to the invention, since the spacer is inserted between the seal section of the thin type battery and the upper sheet, in actual use, the pressure applied to the card surface distributes widely to the seal section of the battery by way of the spacer, thus preventing the concentration of applied pressure on the main body of the battery. The seal section is far stronger than the main body against pressure applied in the thickness direction. Therefore, the inconvenience caused by leakage from the electrode active material can be prevented. At the same time, breakage of the battery seal can be prevented in the heating and laminating step during manufacture. Since the spacer is present between the seal section of the battery and the oversheet, the battery is firmly fixed in the card.

A method of manufacturing an IC card is as follows. The method of manufacturing a card comprises a battery fabricating step that includes fabricating a thin plate battery where the inside of the battery is kept airtight by a seal section. A resin-made frame sheet member is adhered to the seal section. The thickness of the seal section is dimensioned to be less than the thickness of the main body enclosed by the seal section. In a battery accommodating step a thin type battery is accommodated in a cavity formed by overlaying a lower sheet on a core sheet having a penetration pole. An upper sheet is disposed so as to put a lid on the cavity. In a heating and laminating step pressure and heat are applied to the core sheet, lower sheet, and upper sheet from above and beneath to mutually adhere the sheets. A preliminarily formed spacer is inserted between the seal section of the thin type battery and the upper sheet, and the heating and laminating step executed so that the pressing force may be applied to the seal section by way of the spacer.

According to the method of the invention, in the heating and laminating step, the pressure from the press machine is distributed to the seal section by way of the spacer, and concentration of the pressing force on the main body is prevented. The seal section is much stronger than the main body against pressure in the thickness direction. Therefore, the inconvenience caused by leakage from the electrode active material can be prevented. At the same time, in actual use, breakage of the seal can be prevented. Since the spacer is present between the seal section of the battery and the oversheet, the battery is firmly fixed in the card.

As an alternative method for obtaining the same effects, it may be considered to eject fused resin after accommodating the battery in the cavity. However, the number of steps is increased, and an expensive die and ejection forming apparatus will be required along with higher equipment cost. It is hence preferred to insert a preliminarily formed spacer, as in the invention.

The spacer may be preliminarily fitted to the thin type battery. That is, it is the main feature of the thin type battery for the card of the invention that it is a thin type battery used in a card formed by mutually heating and laminating plural layers of resin sheet, having a seal section to which a resin-made frame sheet member is adhered, wherein the thickness of the seal section is less than the thickness of the main body enclosed by the seal section. A spacer is mounted on the principal plane of the seal, and the total thickness of the seal section and spacer is adjusted to be greater than the maximum thickness of the main body. It hence presents a card with a built-in battery that does not break down the seal of the battery during actual use. In the heating and laminating step during card manufacture, seal breakdown of a battery can be effectively suppressed.

To solve the problems, a second aspect of the invention relates to a card comprising a thin plate battery having the inside kept airtight by a seal section to which a resin-made frame sheet member is adhered, wherein the thickness of the seal section is dimensioned to be less than the thickness of the main body enclosed by the seal section. The upper sheet is heated and laminated so as to put a lid on a cavity formed in a core sheet. A spacer of sheet form having rubber elasticity is adjusted in size to settle within the cavity, and is inserted to fit tightly between the thin type battery and the upper sheet.

According to the invention, the card can be heated and laminated so that the spacer may be deformed elastically. As a result, static load is always applied to the thin type battery, and it is firmly fixed in the card. When the battery is consumed and the battery thickness decreases, the spacer elastically restores to follow up the thickness changes, and it hence prevents an inconvenient occurrence, such as the transfer of the thickness decrease of the battery onto the card surface or looseness of the battery within the card. Therefore, the battery is fixed firmly in the card throughout its time of use, and a card of excellent appearance is realized. Moreover, the soft elastic sheet contributes to uniform distribution within the plane of the pressure applied to the main body of the battery, and it is expected to suppress the breakdown of the battery seal in the heating and laminating step.

A method of manufacturing an IC card is as follows. The method of manufacturing the card comprises a battery fabricating step, a battery accommodating step, and a heating and laminating step as mentioned above, in which a spacer of sheet form having rubber elasticity preliminarily formed in size to settle within the cavity is inserted to fit tightly between the thin type battery and the upper sheet. Thereafter, the heating and laminating step is executed.

According to the method of the invention, the card can be heated and laminated so that the spacer may be deformed elastically. As a result, a static load is always applied to the thin type battery, and it is firmly fixed in the card. Moreover, the soft elastic sheet contributes to uniform distribution within the plane of the pressure applied to the main body of the battery, and it is expected to suppress breakdown of the battery seal during the heating and laminating step.

### BRIEF DESCRIPTION OF THE DRAWINGS

FIG. 1 is a sectional schematic view of a first embodiment of an IC card of the invention.

FIG. 2 is a block diagram of the IC card.

FIG. 3 is a partial magnified view of FIG. 1.

FIG. 4 is a sectional schematic view of a deformed example of a spacer.

FIG. 5 is a perspective exploded view showing the manufacturing procedure of the IC card.

FIG. 6 is a sectional schematic view of a second embodiment of an IC card of the invention.

FIG. 7 is a sectional schematic view of a third embodiment of an IC card of the invention.

FIG. 8 is a sectional schematic view showing the state before assembly of the IC card in the third embodiment.

FIG. 9 is a perspective view of a thin type battery.

FIG. 10 is a sectional view of a thin type battery.

FIG. 11 is a magnified sectional view of the composition of a frame type sheet member.

FIG. 12A to FIG. 12D is an explanatory diagram of a manufacturing process for a thin type battery.

FIG. 13 is a perspective view of a thin type battery for an IC card.

FIG. 14 is a perspective view of a thin type battery for an IC card.

### DETAILED DESCRIPTION OF PREFERRED EMBODIMENTS

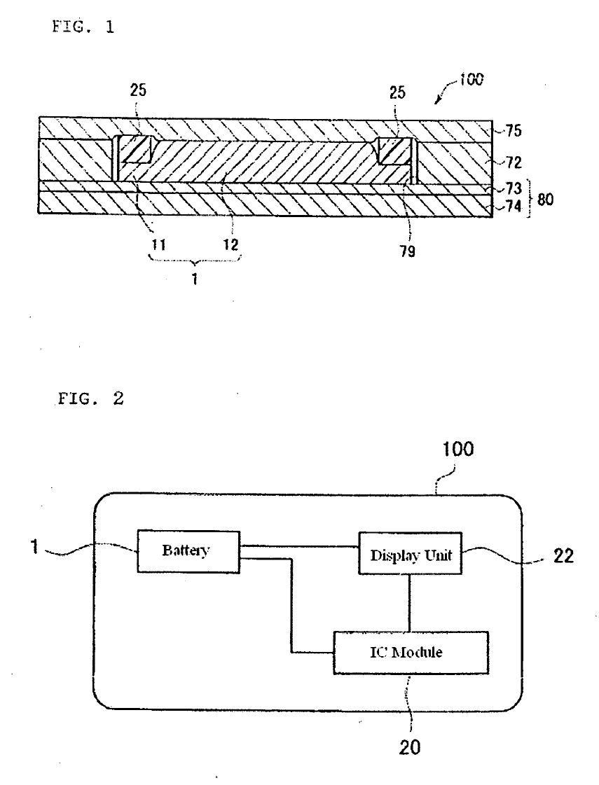

Referring now to the accompanying drawings, preferred embodiments of the invention are described below. FIG. 1 is a sectional schematic view of IC card 100 of the invention. FIG. 2 is a block diagram of the IC card 100. The IC card 100 comprises an IC module 20, a thin plate or thin type battery 1, a display unit 22 and other components. The IC module 20 is an assembled module of electronic components such as an IC chip and capacitor. The thin type battery 1 supplies electric power to the IC module 20 and display unit 22. Further, an antenna coil unit may be provided for supplying electric power by electromagnetic induction, or transmission or reception of data (not shown).

As shown in FIG. 1, the IC card 100 is formed by laminating first oversheet 74, inner sheet 73, core sheet 72, and second oversheet 75 in this sequence. Oversheets 74, 75, inner sheet 73 and core sheet 72 are integrally heated and laminated. The core sheet 72 has a cavity 79 for accommodating thin type battery 1 therein. The thin type battery 1 includes a seal section 11, and a main body 12 of greater thickness than seal section 11. In the card thickness direction, a spacer 25 is inserted between the seal section 11 and the second over sheet 75, so as to fit tightly with them.

The inner sheet 73 supports the thin type battery 1, IC module 20, and display unit 22, and a circuit for supplying electric power and transmitting signals. The inner sheet 73 and first oversheet 74 may be integrated before manufacture of the IC card.

Resin materials for composing oversheets 74, 75, core sheet 72, and inner sheet 73 preferably include PVC (polyvinyl chloride), PET-G (registered trademark of Eastman Chemicals of the United States), biodegradable resin, PET (polyethylene terephthalate), and other thermoplastic resins. PVC is a fusible resin at 140 to 150 deg. C., and it is generally used as a card substrate. PET-G is a noncrystalline polyester resin fusible like PVC. The fusing temperature is 120 to 130 deg. C., which is lower than in PVC. It is excellent in bending and twisting durability, and the combustion generation gas is clean, among other excellent features. Biodegradable resin is relatively low in fusing temperature, that is, 130 to 140 deg. C., but is free from generation of harmful gas in an incineration treatment like PET-G Further, by the function of microorganisms, it is decomposed into water and carbon dioxide, and it can be disposed of by land filling. PET, which is crystalline resin, is not thermally fusible, and it needs to be used together with an adhesive such as a hot-melt adhesive. More specifically, a hot-melt adhesive layer may be thinly formed on one side or both sides of a PET sheet. Hot-melt adhesive is mainly composed of polyvinyl acetate, acrylic resin, ethylene-vinyl acetate copolymer, and other thermoplastic resin. Furthermore, proper additives may be added to these resins, such as pigment and flame retardant.

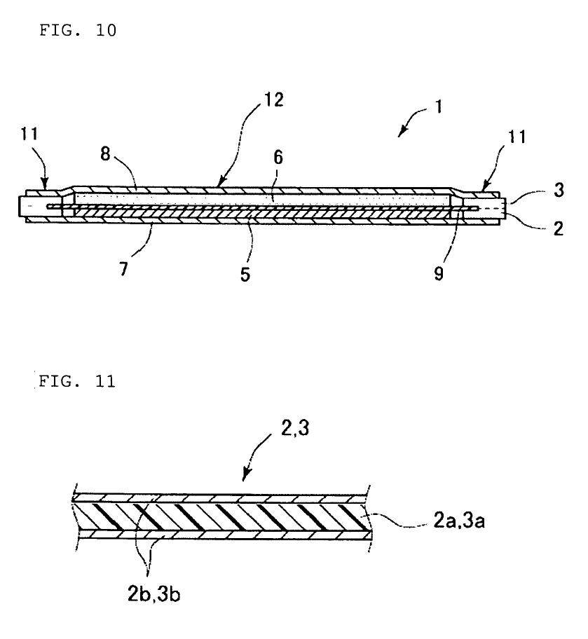

The thin type battery 1 will now be explained in detail. FIG. 9 is a perspective view of thin type battery 1, and FIG. 10 is a sectional view taken along lines A-A in FIG. 9. As shown in FIG. 9 and FIG. 10, the thin type battery 1 has a square shape, and includes a separator 9, a positive electrode active material 6 and a negative electrode active material 5 mutually separated by the separator 9, a pair of window frames 2, 3 (frame type sheet members) enclosing these active materials 5, 6 on the principal plane of the separator 9, and a pair of current collectors 7, 8 having the active materials 5, 6 enclosed with the separator 9. Current collectors 7, 8 serve also as exterior members of the thin type battery 1. The window frames 2, 3 are adhered to each other, and the window frames 2, 3, and both current collectors 7, 8 of the positive electrode and negative electrode are mutually adhered at each electrode side. A seal section 11 is formed to keep the battery inside airtight. The peripheral edge of the separator 9 is held between the pair of window frames 2, 3. The inside portion enclosed by the seal section 11 is the main body 12 of the battery. The first side (negative electrode side) of the thin type battery 1 is nearly flush with the seal section 11 and main body 12, and the second side (positive electrode side) forms a trapezoidal shape.

As shown in a magnified sectional view in FIG. 11, the window frames 2, 3 are composed of hot-melt type adhesive layers 2b, 3b of ethylene vinyl acetate (EVA), ethylene-methacrylic acid copolymer (EMAA), acid denatured polyethylene (PE-a), acid denatured polypropylene (PP-a) or the like, formed at both sides of base materials 2a, 3a composed of thermoplastic resin such as polyethylene (PE), polypropylene (PP), or polyethylene terephthalate (PET). In this embodiment, a three-layer resin sheet having biaxially drawn polypropylene (OPP) enclosed by ethylene-methacrylic acid copolymer is used in window frames 2, 3. In the case of the thin type battery used in the IC card of the ISO standard (ISO/IEC 7810), the thickness of window frames 2, 3 should be, for example, 90 to 150 um. The window frames 2, 3 and current collectors 7, 8 are adhered, and the window frames 2, 3 and separator 9 are adhered, by way of the adhesive layers 2b, 3b.

In the negative electrode active material 5 (first electrode active material), a thin piece of lithium made of lithium metal may be used. That is, the thin type battery 1 is formed as a lithium primary battery. Lithium metal is either lithium or lithium alloy. The thickness of a thin piece of lithium is, for example, 50 to 150 um in the case of the thin type battery used in the IC card of the ISO standard. In the positive electrode active material 6 (second electrode active material), for example, any material containing 60 to 70 mass % of manganese dioxide powder, 1 to 5 mass % of carbon, and 25 to 35 mass % of electrolyte may be preferably used.

Electrolyte solution is composed of lithium salt such as lithium perchlorate (LiClO₄) or lithium trifurate (LiCF₃SO₃) dissolved in an organic solvent such as dimethoxy ethane (DME), ethylene carbonate (EC) or propylene carbonate (PC). The separator 9 is a thin film member capable of isolating the positive electrode and negative electrode, and sufficiently permeating the electrolyte solution. Specifically, separator 9 is a porous, multilayer sheet piece composed of a resin, such as polyethylene or polypropylene. Its thickness is, for example, 20 to 60 um, in the case of the thin type battery used in the IC card of the ISO standard.

The material for current collectors 7, 8 is preferably any one selected from the group of conductive metals consisting of copper, copper alloy, stainless steel, aluminum, nickel, and nickel alloy. In particular, stainless steel is preferred because it is excellent in processability, corrosion resistance, and economy. Specifically, it is recommended to use SUS301, SUS304, SUS316, SUS316L as representative examples of an austenitic stainless steel, or SUS631 as a representative example of a precipitation hardening stainless steel.

Returning now to FIG. 1, spacer 25 will now be explained in detail. The spacer 25 functions to suppress the concentration of pressure applied to the surface of the IC card 100 on the main body 12 of the thin type battery 1. The seal section 11 of the thin type battery 1 is a portion not supporting the electrode active material, and it is strong and resistant to pressure applied in the thickness direction. FIG. 3 is a partial magnified view of FIG. 1. As shown in FIG. 3, total thickness D₂ of seal section 11 of thin type battery 1 and spacer 25 is adjusted to be greater than the maximum thickness D₁ of the main body 12 of the thin type battery 1. As a result, when a surface pressure is applied to the second oversheet 75 of the IC card 100, pressure is applied predominantly on the seal section 11 of the thin type battery 1, and a sufficient breakdown preventive effect of seal section 11 is obtained. For such dimensional adjustment of the spacer 25 a preliminarily formed spacer 25 is inserted, since it is difficult to make such dimensional adjustment by a method of filling the cavity 79 with resin.

The spacer 25 can be mainly composed of a resin that is hardly cured by the heat applied to the resin composing the oversheets 74, 75 and core sheet 72. Thus, in the heating and laminating step described below, melting or softening of the spacer 25 can be prevented. However, when the oversheets 74, 75 and core sheet 72 are composed of PET, a hot-melt adhesive layer is provided between sheets. The heating temperature in the heating and laminating step is determined by the softening temperature of the hot-melt adhesive layer. Hence, the spacer 25 is made of a resin that is hardly cured at the softening temperature of the hot-melt adhesive. Specifically, when using a hot-melt adhesive of which the softening temperature is less than 150 deg. C., a resin selected from the group consisting of polypropylene, PET, polyimide, polycarbonate, epoxy resin, ABS (acrylonitrile-butadiene-styrene copolymer), PVC and PEN (polyethylene naphthalate) can be processed into a film, and used as spacer 25. Softening temperature of the resin is nearly equal to the glass transition temperature.

The spacer 25 may be also composed mainly of a high molecular material having rubber elasticity. Specifically, silicone resin and other elastomers that do not melt at the heating and laminating temperature in the manufacture of IC card 100 can be used. When the spacer 25 has rubber elasticity, the following dominant effects are obtained. In the lithium primary battery (thin type battery 1) shown in FIG. 9 and FIG. 10, lithium moves to the positive electrode side by discharge, but at this time the thickness of the battery tends to gradually decrease. As a result, the thin type battery 1 firmly fixed at the time of manufacture of IC card 100, may gradually become loosened in the IC card. However, by allowing the spacer 25 to deform elastically at the time of manufacture, if the thickness of the thin type battery 1 decreases, the decrement can be canceled by the gradual elastic restoration of the spacer 25. Hence, spacer 25 prevents loosening of the thin type battery 1 in the card, or transfer of the shape change of the thin type battery 1 onto the card surface. Furthermore, when a static load in the thickness direction is always applied to the thin type battery 1, mutual contact tightness of the electrode active materials, separator and metal current collectors is enhanced, and it is advantageous from the viewpoint of a decrease of internal resistance.

Preferably, the spacer 25 should have a frame shape along the seal section 11 of the thin type battery 1. For example, it is possible to install the spacer only along two diagonal sides of the square-shaped thin type battery cell 1 In this embodiment, by disposing the spacer 25 so as to surround the main body 12 of the battery 1, the significant effects explained so far can be exhibited to the maximum extent.

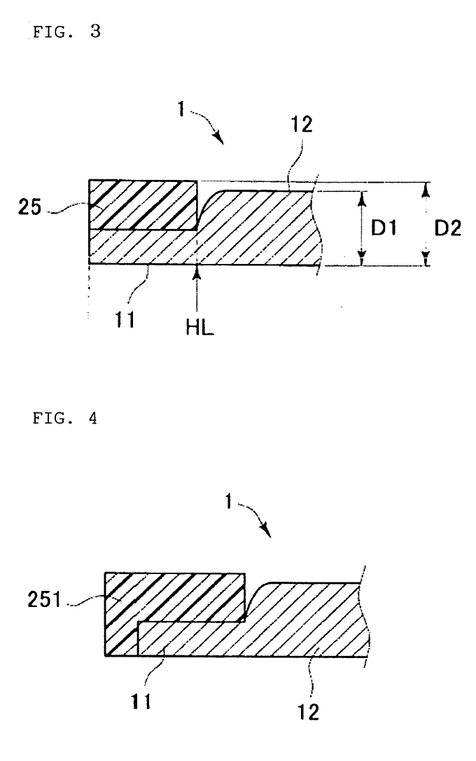

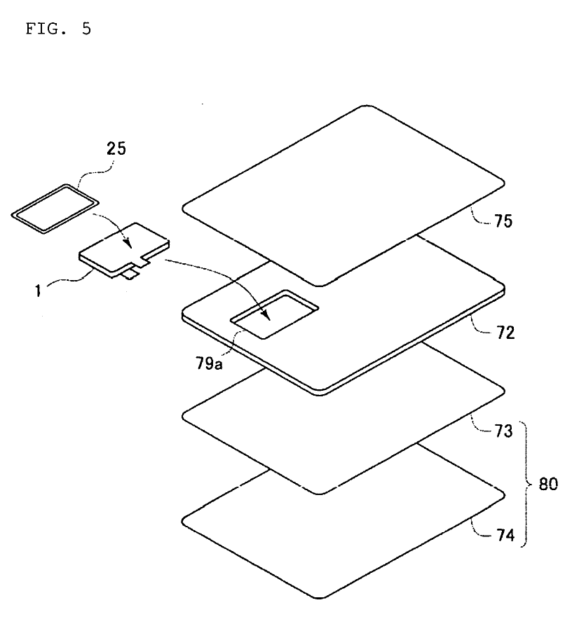

As shown in FIG. 3, the spacer 25 may be adjusted in dimensions so that its inner peripheral edge may coincide with boundary HL of seal section 11 of thin type battery 1 and main body 12. Since the spacer 25 does not interfere with the main body 12 in this configuration, damage on the main body 12 may be more effectively decreased. The outer peripheral edge of the spacer 25 should coincide with the outer peripheral edge of the thin type battery 1. Or in a range settling within the cavity 79 of the IC card 100, it may be extended outward over the outer peripheral edge of the thin type battery 1. For example, spacer 251 shown in FIG. 4 is extended outward over the outer peripheral edge of the seal section 11, and is formed in an L-section in a form along the side face of the seal section 11. As a result, a higher fixing effect is expected.

The main body 12 of the thin type battery 1 is nearly flush with the seal section 11 on a first side (negative electrode side), and tightly contacts with the inner sheet 73. On a second side (positive electrode side), the main body 12 almost contacts tightly with the second oversheet 75.

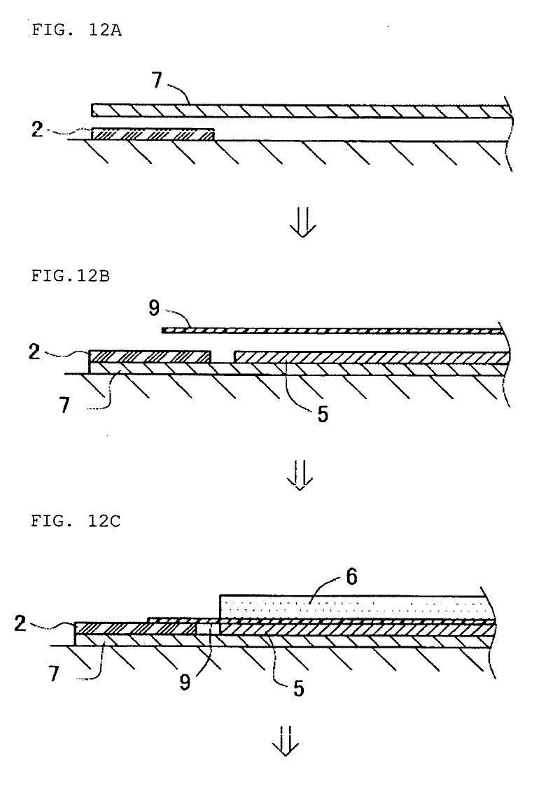

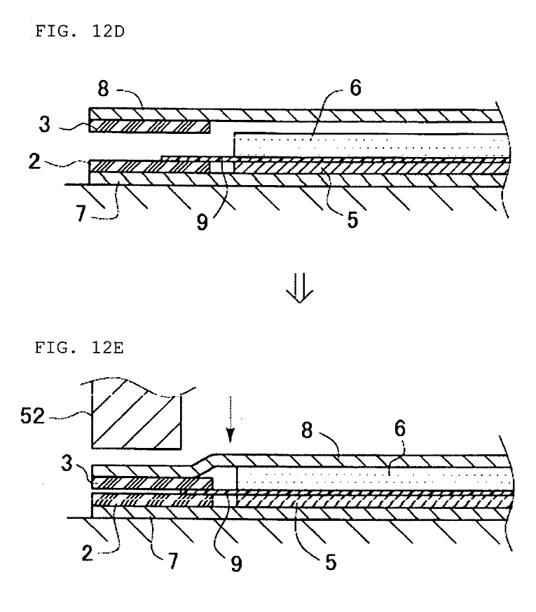

The IC card 100 can be manufactured according to the following procedure. The fabricating process of thin type battery 1 is explained by reference to the explanatory diagrams shown in FIG. 12A to FIG. 12D. The current collector 7 at the negative electrode side is brought into contact with the surface of the window frame 2, and the adhesive layer of the window frame 2 is fused by ultrasonic fusion method or thermal fusion method, thus adhering the current collector 7 to the window frame 2 (FIG. 12A). The assembly of the window frame 2 and current collector 7 is turned over, and a lithium thin plate 5 is mounted on the current collector 7 as negative electrode material. From above the lithium thin plate 5, a separator 9 is placed so that its peripheral edge may contact with the surface of the window frame 2 (FIG. 12B). At this time, to prevent deviation of the position of separator 9, it is preferred to preliminarily apply adhesive or the like to the separator 9 or window frame 2.

By use of a thick film printing method using a metal mask, a slurry containing MnO₂ is printed on the principal plane of the separator 9 as a positive electrode active material (FIG. 12C). The current collector 8 of the positive electrode side is preliminarily bonded to the window frame 3 to cover the slurry layer 6 (FIG. 12D). Finally, in vacuum atmosphere or while sucking air from the window frames 2, 3, an ultrasonic horn 52 is brought into contact with the current collector 8, and the window frames 2, 3 are fused to each other, thereby fabricating a thin type battery 1 (FIG. 12E).

While fabricating the thin type battery 1, as shown in FIG. 5, an inner sheet 73 having IC module 20, display unit 22 and circuit, a core sheet 72 having penetration hole 79a, oversheets 75, 74, and spacer 25 are manufactured. The penetration hole 79a of the core sheet 72 can be formed by blanking or other process. The spacer 25 is dimensioned to just fit the penetration hole 79a of the core sheet 72. Next, so as to plug the penetration hole 79a of the core sheet 72 from one side, a lower sheet 80 composed of inner sheet 73 and first oversheet 74 is overlaid on the core sheet 72, and a cavity 79 for accommodating the battery is formed. The thin type battery 1 is accommodated in cavity 79. The spacer 25 is put on the thin type battery 1, and a second oversheet 75 is placed so as to put a lid on the cavity 79 (battery accommodating step). In FIG. 5, for the sake of simplicity, the IC module 20, display unit 22 and accommodating section are omitted.

In this way, after arranging the thin type battery 1 and spacer 25, and matching with the sheets, the core sheet 72, inner sheet 73, and oversheets 75, 74 are pressed while heating from above and beneath by a press machine, and the sheets are mutually adhered (heating and laminating step). This heating and laminating step can be executed while adjusting to a temperature range that will not soften or fuse the spacer 25. The heating and laminating step can be also executed in a vacuum atmosphere. In this manner, the IC card 100 shown in FIG. 1 can be obtained.

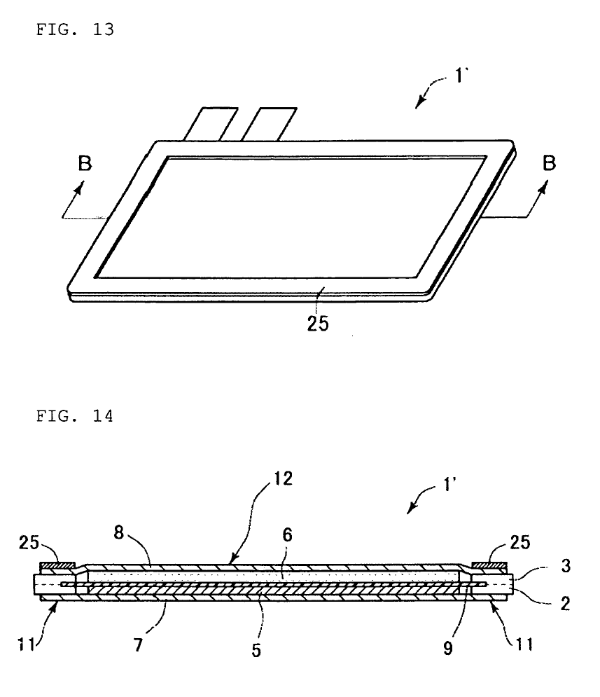

Alternatively, a multiple-piece IC card work having mutually linking multiple IC cards may be manufactured, blanked by punch or the like, and separated into individual IC cards 100. According to this method, matching of resin sheets is easy, it is not necessary to handle components individually, and high productivity is expected. As shown in FIG. 13 and FIG. 14, by preliminarily adhering the spacer 25 to the seal section 11, the problem of spacer 25 deviating in position in the battery accommodating step and the heating and laminating step can be avoided, and a favorable thin film battery 1′ for IC card can be presented. That is, the assembling step of spacer 25 can be incorporated in the assembling process of thin type battery 1 shown in FIG. 12A to FIG. 12E. In this case, as explained in FIG. 3, preferably, the thickness of the spacer 25 should be dimensioned so that the total thickness of the seal section 11 and spacer 25 may be more than the total thickness of the main body 12.

### Second Embodiment

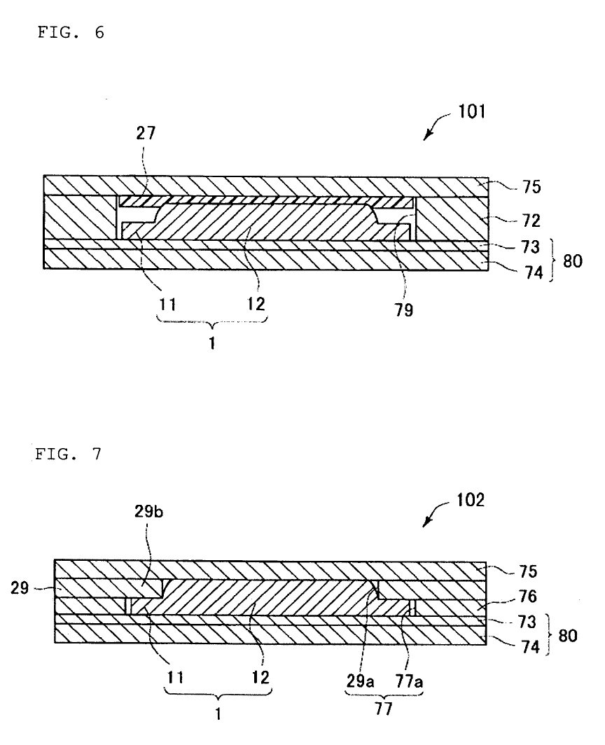

An IC card 101 shown in FIG. 6 is an example of a spacer 27 of sheet form having rubber elasticity adjusted in size to be received in a cavity 79 and, being inserted to contact tightly between a main body 12 of a thin type battery 1 and a second oversheet 72. The size of the spacer 27 is preferably adjusted to contact with the entire surface of the main body 12. The constituent material for the spacer 27 is preferably an elastomer having a proper heat resistance, such as silicone resin. The heat resistance allows mutual adhesion of oversheets 74, 75, inner sheet 73, and core sheet 72, but not allow fusion at the heating and laminating temperature for obtaining IC card 101. The thin type battery 1, oversheets 74, 75, inner sheet 73, and core sheet 72 are the same as mentioned above.

The heating and laminating step for fabricating the IC card 101 may be preferably done in a temperature range for allowing mutual adhesion of oversheets 74, 75, inner sheet 73, and core sheet 72, and not allowing fusion of spacer 27. The spacer 27 is deformed elastically, and applies a static load to the thin type battery 1. A soft spacer 27 absorbs surface undulations of the main body 12 of the thin type battery 1, and contributes to prevention of seal breakdown. The spacer 27 may be preliminarily fitted to the thin type battery 1.

### Third Embodiment

In an IC card 102 shown in FIG. 7, a spacer sheet 29 is provided that has an opening 29a dimensioned to receive main body 12 of thin type battery 1, but not allow receipt of seal section 11. Spacer sheet 29 is inserted between a second oversheet 75 and a core sheet 76. The spacer sheet 29 is composed as a sheet member to be integrally adhered to the second oversheet 75 and core sheet 76. An opening peripheral edge 29b of the spacer sheet 29 is adhered to the seal section 11 of the thin type battery 1 at the first side, and to the oversheet 75 at the second side. In other words, a stepped cavity is formed by the core sheet 76 and spacer sheet 29, and the thin type battery 1 is accommodated within the stepped cavity. The thin type battery 1, oversheets 74, 75, and inner sheet 73 are the same as mentioned above. The core sheet 76 is dimensioned thinner than the thin type battery 1 in order to insert the spacer 29.

The spacer sheet 29 can be composed of the same resin material as the oversheets 74, 75, inner sheet 73, and core sheet 76, specifically, PVC, PET-C, biodegradable resin, PET, and other thermoplastic resin, as mentioned above. That is, spacer sheet 29 also serves as the spacer contributing to prevention of seal breakdown of the thin type battery 1, as well as the base material of IC card 102.

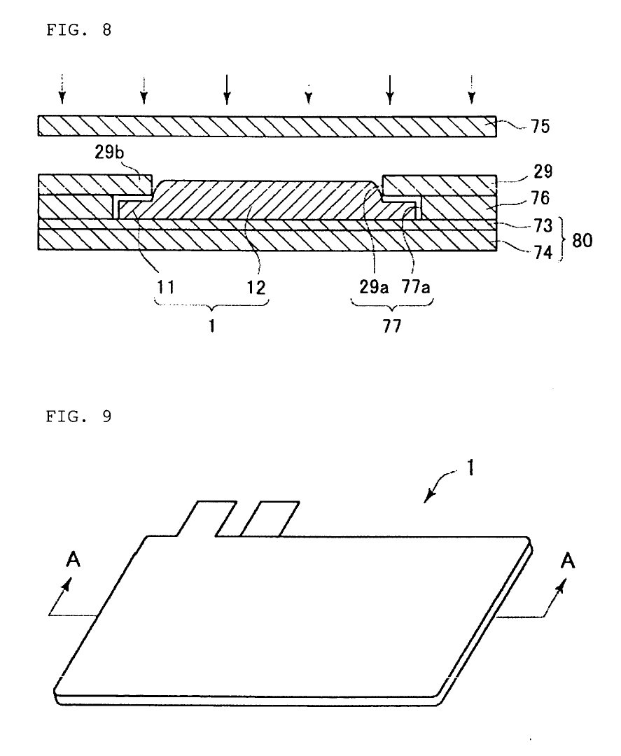

FIG. 8 is a sectional schematic view before start of the heating and laminating step for fabricating the IC card 102 in FIG. 7. The thickness of core sheet 76 is dimensioned to be greater than the thickness of seal section 11 of thin type battery 1. The total thickness of core sheet 76 and spacer sheet 29 is greater than the maximum thickness of the thin type battery 1. The core sheet 76 has an opening 77a sufficiently dimensioned to receive the thin type battery 1, and the spacer sheet 29 has an opening 29a smaller in size than the opening 77a of the core sheet 76. The thin type battery 1 is received in a stepped cavity 77 formed by blocking openings 29a, 77a from one side with lower sheet 80. There is a slight gap between the opening peripheral edge 29b of the spacer sheet 29 and the seal section 11 of the thin type battery 1, but along with the progress of the heating and laminating step, each sheet is softened gradually, and the thickness decreases. As a result, the opening peripheral edge 29b of the spacer 29 is gradually applied on the seal section 11 of the thin type battery 1, and pressure is applied to the seal section 11. Concentration of pressure on the main body 12 of the thin type battery 1 is prevented. Hence, leakage of electrode active material can be prevented.

In the specification, by “mainly,” it means that the component is contained most by mass %. Vacuum refers to a state evacuated and reduced in pressure from the atmospheric pressure. A card having a built-in storage device or microcomputer is more specifically referred to as an IC card. The present invention is useful for a card incorporating a thin type battery, even if the card does not incorporate a storage device or microcomputer.

Having described the invention, the following is claimed:

1. A card comprising:
a thin plate battery including:
a main body,
a seal section for keeping the inside of the battery airtight and enclosing the main body, and
a resin-made frame sheet member adhered to the seal section, wherein the thickness of the seal section is less than the thickness of the main body enclosed by the seal section;
a core sheet including a cavity;
an upper sheet, said upper sheet covering the cavity; and
a spacer located between the seal section of the thin plate battery and the upper sheet.

2. The card of claim 1, wherein total thickness D₂ of said seal section and said spacer is greater than maximum thickness D₁ of said main body of the thin plate battery.

3. The card of claim 1, wherein
said spacer is comprised of a first resin;
said upper sheet is comprised of a second resin;
said core sheet is comprised of a third resin, said core sheet adhered to said upper sheet by a thermofusible resin, wherein said first resin is less likely to be softened by heating than the second resin and/or the third resin, or the thermofusible resin.

4. The card of claim 1, wherein said spacer is comprised of a high molecular material having rubber elasticity.

5. The card of claim 1, wherein the spacer has a frame shape conforming to said seal section of the thin plate battery.

6. The card of claim 1, wherein said spacer is a sheet member inserted between said upper sheet and said core sheet, and integrally adhered thereto, said spacer including an opening dimensioned to receive only said main body of the thin type battery.

7. A card comprising:
a thin plate battery including:
a main body,
a seal section enclosing the main body and providing an airtight seal, the seal section having a thickness that is less than the thickness of the main body, and
a resin-made frame sheet member adhered to the seal section,
a core sheet having a cavity;
an upper sheet covering the cavity; and
a spacer having a sheet form and rubber elasticity, said spacer having an adjustable size to allow insertion into the cavity, said spacer fitting tightly between the thin plate battery and the upper sheet.

8. A method for manufacturing a card comprising:
a battery fabricating step for fabricating a thin plate battery including: enclosing a main body with a seal section, wherein the seal section provides an airtight seal, and adhering a resin-made frame sheet member to the seal section, wherein the thickness of the seal section is less than the thickness of the main body;
a battery accommodating step including: forming a cavity by overlaying a lower sheet on a core sheet having a penetration pole, locating the thin plate battery in the cavity, and disposing an upper sheet over the cavity; and
a heating and laminating step including: inserting a spacer between the seal section of the thin plate battery and the upper sheet, applying a pressing force and heat to the core sheet, the lower sheet, and the upper sheet from above and beneath to mutually adhere, said pressing force applied to the seal section by way of a spacer.

9. The method of claim 8, wherein total thickness D₂ of said seal section of the thin plate battery and said spacer is greater than a maximum thickness D₁ of said main body of the thin plate battery.

10. The method of claim 9, wherein the spacer is formed of a first resin less likely to be softened by heating than a second resin forming said upper sheet and/or a third resin forming said core sheet, or a thermofusible resin for adhering said upper sheet and said core sheet, said heating and laminating step being executed in a temperature range for adhering said upper sheet and said core sheet, but not fusing said spacer.

11. The method of claim 8, wherein said spacer is comprised of a high molecular material having a rubber elasticity.

12. The method of claims 8, wherein said spacer has a frame shape conforming to said seal section of the thin plate battery.

13. The method of claims 8, wherein said spacer is a sheet member, said sheet member being inserted between said upper sheet and said core sheet, said sheet member having an opening dimensioned to only receive said main body of the thin plate battery.

14. A method of manufacturing a card comprising:
a battery fabricating step of fabricating a thin plate battery including: enclosing a main body with a seal section, wherein the seal section provides an airtight seal, and adhering a resin-made frame sheet member to the seal section, wherein thickness of the seal section is less than thickness of the main body;
a battery accommodating step including: forming a cavity by overlaying a lower sheet on a core sheet having a penetration pole, locating the thin plate battery in the cavity, and disposing an upper sheet over the cavity; and
a heating and laminating step including: (a) inserting into the cavity a spacer of a sheet form having rubber elasticity, said spacer dimensioned to be received within the cavity between the thin plate battery and the upper sheet, so as to be in tight contact with both, and (b) pressing and heating the core sheet, lower sheet, and upper sheet from above and beneath to mutually adhere.

15. A thin type battery for a card formed by mutually heating and laminating plural layers of resin sheet, the battery comprising:
a main body; and
a seal section enclosing the main body and to which a resin-made frame sheet member is adhered, wherein thickness of the seal section is less than thickness of the main body enclosed by the seal section, wherein a spacer is mounted on a principal plane of the seal section, and total thickness D₂ of the seal section and the spacer is greater than maximum thickness D₁ of main body.

16. The thin type battery of claim 15, wherein the spacer is a resin-made sheet member having a frame shape conforming to said seal section.

17. The thin type battery of claim 15, wherein said battery is a lithium primary battery using lithium or lithium alloy as a negative electrode active material, and an oxide of a transition metal as a positive electrode active material.
